(19) United States
(12) Patent Application Publication
(10) Pub. No.: US 2026/0208853 A1
(43) Pub. Date: Jul. 23, 2026

(54) AERONAUTICAL THRUSTER

(71) Applicants: Safran Aircraft Engines, PARIS (FR); CENTRE NATIONAL DE LA RECHERCHE SCIENTIFIQUE (CNRS), PARIS (FR)

(72) Inventors: Fernando GEA AGUILERA, MOISSY-CRAMAYEL (FR); Jean AL AM, ECULLY (FR); Vincent Jacques Charles CLAIR, ECULLY (FR); Alexis Vincent GIAUQUE, ECULLY (FR); Jérôme Christophe BOUDET, ECULLY (FR)

(73) Assignees: Safran Aircraft Engines, PARIS (FR); CENTRE NATIONAL DE LA RECHERCHE SCIENTIFIQUE (CNRS), PARIS (FR)

(21) Appl. No.: 19/136,503

(22) PCT Filed: Dec. 8, 2023
(86) PCT No.: PCT/FR2023/051959

§ 371 Date: Jun. 6, 2025

(30) Foreign Application Priority Data
Dec. 9, 2022 (FR) 2213108

(51) Int. Cl. B64C 11/18; B64C 11/20; B64D 27/10; B64D 35/00; F02K 3/00

(52) U.S. Cl. CPC B64C 11/18; B64C 11/20; B64D 27/10; B64D 35/00; F02K 3/00

(57) ABSTRACT

The invention relates to an aeronautical thruster comprising a blade, the blade comprising a profiled part (85) having an aerodynamic profile extending radially from the central component, the profiled part (85) having a leading edge (86), a trailing edge (87), a lower surface and an upper surface (89), wherein the lower surface (88) or the upper surface (89) comprise a textured surface portion (90) having a series of projections and/or recesses, the textured surface portion (90) being defined such that any given point of the textured surface portion (90) is located at a radial distance from the main axis of the aeronautical thruster equal to the sum of a minimum radius (Rmin) and between 20% and 95% of a span of the profiled part (85), and is located at an axial distance from the leading edge comprised between 2% and 50% of the local chord length.

### FIELD OF THE INVENTION

The invention relates to an aeronautical thruster, such as a gas turbine engine.

### PRIOR ART

Aeronautical thrusters comprise fixed parts and rotating parts, which are driven in rotation with respect to the fixed parts when the aeronautical thruster is in operation.

The rotating and fixed parts each have blades.

For example, gas turbine engines typically comprise a fan module or propeller module, a compressor module, a combustion chamber and a turbine module.

The fan module (or propeller module), the compressor module and the turbine module each comprise rotating parts (or “rotors”) and fixed parts (or “stators”).

For example, the fan module comprises a fan stator and a fan rotor proper to rotate with respect to the fan stator. The fan rotor comprises one or more rows of moving blades. Rotation of the fan rotor has the effect of compressing air, which is expelled rearwards to produce part of the engine's thrust.

In addition, the fan stator generally comprises an assembly of Outlet Guide Vanes (OGVs) downstream of the fan rotor, which act as a flow-straightener. The purpose of this assembly of vanes is to straighten and regulate the airflow downstream of the fan rotor, in order to optimise engine thrust.

The airflow through the fixed vane assembly generally flows between the fixed vanes in an upstream-to-downstream direction.

However, under certain engine operating conditions, particularly at partial speed (i.e. during the take-off and landing phases of the aircraft), separation/recirculation bubbles and/or areas of partially detached flow may appear on the blade surfaces, in particular on the extrados surfaces. These recirculation bubbles generate noise.

On the one hand, these recirculation bubbles produce lines (tonal noise) at high frequencies, which are linked to the presence of these bubbles and the associated vortex detachment. On the other hand, recirculation bubbles increase the thickness of the boundary layer, which has an impact on the wake of the fan rotor and on the interaction noise with the fan stator or the row of fixed vanes located downstream. A recirculation bubble that is too large increases the turbulent kinetic energy and the velocity deficit in the wake, which in turn increases the interaction noise (broadband and tonal, respectively).

The same phenomenon can occur on unducted propellers of turboprops, counter-rotating open rotor (CROR) gas turbine engines and unducted fans of unducted single fan (USF) gas turbine engines.

This same phenomenon can also occur on other fixed vanes or moving blades of an aeronautical thruster.

The document EP 3 467 258 A1 discloses in particular a blade for a gas turbine engine, the blade comprising a pressure surface and a suction surface, wherein the pressure surface or the suction surface comprises an area of roughness which is configured to provide greater resistance to flow in a direction along the blade than in a direction across the blade.

### SUMMARY OF THE INVENTION

One aim of the invention is to reduce the noise generated by a blade in the presence of a recirculation bubble and/or areas with a partially detached flow which appear at certain speeds, without penalising the operation of the aeronautical thruster at other speeds.

This aim is achieved within the context of the present invention by means of an aeronautical thruster comprising a fixed part and a rotating part proper to be driven in rotation with respect to the fixed part about a main axis of the aeronautical thruster, one of the fixed part and the rotating part comprising a central component and a blade, the blade comprising a profiled part having an aerodynamic profile extending radially from the central component,
the profiled part having a leading edge, a trailing edge, an intrados surface and an extrados surface,
wherein the intrados surface or the extrados surface comprises a textured surface portion having a series of projections and/or recesses,
the textured surface portion being defined such that any considered point of the textured surface portion is located at a radial distance from the main axis of the aeronautical thruster equal to the sum of a minimum radius and between 20% and 95% of a span of the profiled part, and is located at a distance from the leading edge of between 2% and 50% of the local chord length,
wherein the span of the profiled part is defined as a difference between a maximum radius of the profiled part and a minimum radius of the profiled part, the maximum radius being defined as a distance between a point of the profiled part furthest away from the main axis of the aeronautical thruster, and the main axis of the aeronautical thruster, and the minimum radius being defined as a distance between a point of the leading edge of the profiled part closest to the main axis of the aeronautical thruster, and the main axis of the aeronautical thruster, or in the case where the blade is a variable pitch blade, the minimum radius being defined as a distance between a point of the leading edge of the profiled part closest to the main axis of the aeronautical thruster, and the main axis of the aeronautical thruster, when the blade is positioned with a pitch angle at which the blade is feathered, and
wherein the local chord length is defined as a distance between a point of the leading edge and a point of the trailing edge, the point of the leading edge and the point of the trailing edge being located at the same radial distance from the main axis as the point considered.

The textured surface portion thus defined lies in an area in which a recirculation bubble and/or partially detached flow is capable of occurring.

The presence of a series of projections and/or recesses in this area makes it possible to recreate a turbulent flow at this point, instead of a recirculation bubble at partial speed (i.e. during the take-off and landing phases of the aircraft) and to reduce parietal friction and aerodynamic losses at nominal speed (i.e. at cruise speed). This enables the noise generated by the fan to be reduced during take-off and landing, without impacting the performance of the aeronautical thruster at cruise speed.

The aeronautical thruster may also have one or more of the following features:
the textured surface portion is a portion of the extrados surface and the series of projections and/or recesses consists of an alternation of projections and recesses,
the textured surface portion is defined such that any considered point of the textured surface portion is located at a radial distance from the main axis of the aeronautical thruster equal to the sum of a minimum radius and between 50% and 90% of a span of the profiled part,
the textured surface portion is defined such that any considered point of the textured surface portion is located at a radial distance from the main axis of the aeronautical thruster greater than a radial distance of a point of the leading edge of the profiled part located furthest upstream, considering that the main axis of the thruster extends from upstream to downstream in the direction of flow of the gases through the aeronautical thruster, when the aeronautical thruster is in normal operation,
the textured surface portion is defined such that any considered point of the textured surface portion is located at an axial distance from the leading edge of between 5% and 40% of the local chord length, preferably between 10% and 30% of the local chord length,
for any considered point of the textured surface portion, the thickness of the profiled part at the point considered is less than 12% of the local chord, preferably less than or equal to 10% of the local chord, or more preferably less than or equal to 7% of the local chord,
the thickness of the profiled part at the point considered is greater than 0.1% of the local chord, preferably greater than 0.25% of the local chord, or more preferably greater than 1% of the local chord,
for a given radial distance, the profiled part has a maximum thickness at a given point of the intrados surface or of the extrados surface, and any considered point of the textured surface portion is located upstream of the point where the thickness of the profiled part is maximum,
for a given radial distance, the profiled part has a maximum thickness at a given point of the intrados surface or of the extrados surface, the given point being located at a distance from the leading edge of between 10% and 45% of the local chord, preferably between 15% and 30% of the local chord,
the profiled part comprises a core made of composite material and an insert fixed to the core and forming the leading edge of the profiled part, and the projections and recesses are formed solely on the insert,
the insert is a metal reinforcement fixed to the core or a heating mat fixed to the core,
the projections and/or recesses are located at a radial distance from the main axis greater than a radial distance from the maximum of the local chord of the blade with respect to the main axis, or greater than the radial distance from a belly of the leading edge with respect to the main axis,
the projections and/or the recesses are formed in the insert by machining,
alternatively, the projections and/or recesses are also formed on the core made of composite material,
the projections and/or recesses are formed in a film attached on the core made of composite material,
the intrados surface or the extrados surface comprises a plurality of textured portions having a series of projections and/or recesses, and wherein one textured surface portion is separated from another closest textured surface portion by a distance of between 1% and 35% of the span, preferably between 2% and 15% of the span,
the projections have a height of between 0.04% of the local chord, preferably 1%, and 3% of the local chord and/or the recesses have a depth of between 0.04% of the local chord, preferably 1%, and 3% of the local chord,
the projections and/or recesses form a repetitive pattern having a constant pitch between two consecutive projections or between two consecutive recesses, the pitch being between ⅓ and 3 times a height of a projection, or between ⅓ and 3 times a depth of a recess,
the recesses comprise cavities, each cavity having the shape of a portion of a sphere, for example a hemispherical shape,
the projections comprise ribs,
each rib has a base and a ridge having a height measured with respect to the base which increases in a strictly monotonic manner from upstream to downstream,
the ridge has an upstream end and a downstream end, and each rib comprises an upstream end face extending from the base to the upstream end of the ridge, forming a first non-zero angle with the base, less than or equal to 90°, and a downstream end face extending from a downstream end of the ridge to the base, forming a second non-zero angle with the base, less than or equal to 90°,
the upstream end face has a flat portion extending from the base and a rounded junction portion extending from the flat portion to the upstream end of the ridge,
the first angle is between 20° and 70°,
the second angle is between 20° and 70°,
the downstream end face has a rounded junction portion extending from the downstream end of the ridge and a flat portion extending from the rounded junction portion to the base,
each rib has a section with triangular cross-section, with a base and an apex, the apex having a height measured with respect to the base greater than the width of the base,
the textured surface portion comprises first zones and second zones disposed alternating with the first zones along a radial direction with respect to the main axis, and each first zone has a series of first ribs, oriented at a first angle with respect to the main axis of the aeronautical thruster, and each second zone has a series of second ribs oriented at a second angle with respect to the main axis, the second angle being different from the first angle,
the first angle and the second angle are adjacent and the first angle is between +15° and +45° with respect to the main axis of the engine and the second angle is between −15° and −45° with respect to the main axis of the engine,
the alternation of first zones and second zones has a spatial period of between 5% and 20% of the local chord,
each first rib converges towards a respective second rib in the upstream-downstream direction,
the aeronautical thruster comprises a ducted fan or an unducted propeller, and the blade is a blade of the ducted fan or of the unducted propeller of the aeronautical thruster,
the blade is a variable pitch blade,
the aeronautical thruster comprises a turbine driving the fan or the propeller, a fan shaft or a propeller shaft connected to the fan or to the propeller, a turbine shaft connected to the turbine, and a reduction mechanism having an input connected to the turbine shaft and an output connected to the fan shaft or to the propeller shaft, such that in operation, the fan or the propeller is rotated by the turbine at a speed of rotation less than a speed of rotation of the turbine.

### DESCRIPTION OF THE DRAWINGS

Other features and advantages will emerge from the following description, which is given purely by way of illustration and not being limiting and which should be read with reference to the attached figures, in which:

FIG. 1 schematically shows a first example of an aeronautical thruster, comprising an unducted propeller module,

FIG. 2 schematically shows a second example of an aeronautical thruster, comprising a ducted fan module,

FIG. 3 schematically shows, in longitudinal cross-section, a ducted-fan gas turbine engine,

FIG. 4 schematically shows a fan or propeller blade,

FIG. 5 schematically shows, in transverse cross-section, the fan or propeller blade of FIG. 4,

FIG. 6 schematically shows a fan or propeller blade according to an embodiment of the invention,

FIG. 7 schematically shows, in transverse cross-section, the fan or propeller blade of FIG. 6,

FIG. 8 schematically shows, a fan or propeller blade profile and the camber line in the section plane,

FIG. 9 is an enlarged view of a textured surface portion of the fan or propeller blade, according to one possible embodiment of the invention,

FIG. 10A schematically shows the shape of a projection formed in the extrados portion according to a first embodiment of the invention,

FIG. 10B schematically shows the shape of a projection formed in the extrados portion according to a second embodiment of the invention,

FIG. 11 schematically shows an alternation of projections and recesses formed in the textured surface portion of the fan or propeller blade,

FIG. 12 schematically shows the angles of orientation of the projections, the projections having the form of ribs,

FIG. 13 schematically shows, in transverse cross-section, a blade comprising a projection,

FIG. 14 is an enlarged view of a textured surface portion of the fan blade, according to another possible embodiment of the invention,

FIG. 15 schematically shows, in transverse cross-section, the blade of FIG. 14,

FIGS. 16A to 16F illustrate various configurations of the textured surface portion.

### DETAILED DESCRIPTION OF AN EMBODIMENT

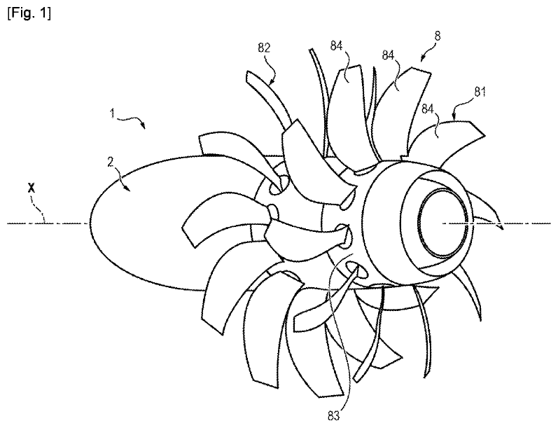

The aeronautical thruster 1 shown in FIG. 1 is an unducted-propeller gas turbine engine. The gas turbine engine 1 is an open rotor type gas turbine engine, in what is commonly referred to as “pusher” configuration (i.e. the fan is positioned downstream of the power generator with the air inlet located upstream, on the left in FIG. 1).

The gas turbine engine 1 comprises a nacelle 2 intended to be fixed to a fuselage of an aircraft, and an unducted fan 8. The fan 8 comprises two counter-rotating fan rotors 81 and 82. In other words, when the engine 1 is in operation, the rotors 81 and 82 are rotated with respect to the nacelle 2 about a same axis of rotation X (which coincides with the main axis of the engine), in opposite directions.

In the example illustrated in FIG. 1, the engine 1 is a contra-rotating open rotor (CROR) engine, in pusher configuration. However, the invention is not limited to this configuration. The invention also applies to open rotor engines in puller configuration (i.e. the fan is placed upstream of the power generator with its air inlet located in front, between or just behind the two fan rotors).

In addition, the invention also applies to engines having different architectures, such as an architecture comprising a fan rotor comprising moving blades (open fan) and a fan stator comprising vanes (unducted single fan, USF) or even a single fan rotor.

The fan stator vanes may be fixed or variable pitch. In the latter case, each of the vanes is mounted so that it can pivot with respect to the nacelle 2 along a pitch axis.

The invention is applicable to turboprop architectures (comprising a single fan rotor).

In FIG. 1, each fan rotor 81, 82 comprises a hub 83 mounted to rotate with respect to the nacelle 2 and a plurality of blades 84 attached to the hub 83. The blades 84 extend substantially radially relative to the axis of rotation X of the hub.

The blades 84 may be fixed or variable pitch blades. Fixed blades are fixedly mounted on the hub 83. If the blades 84 are variable pitch blades, each blade 84 is mounted so as to pivot with respect to the hub 83 about a respective pitch axis Y. The blades 84 are connected to a pitch change mechanism enabling the angle of pitch of the blades 84 with respect to the hub 83, and thus their angle of incidence, to be adjusted as a function of the flight phases.

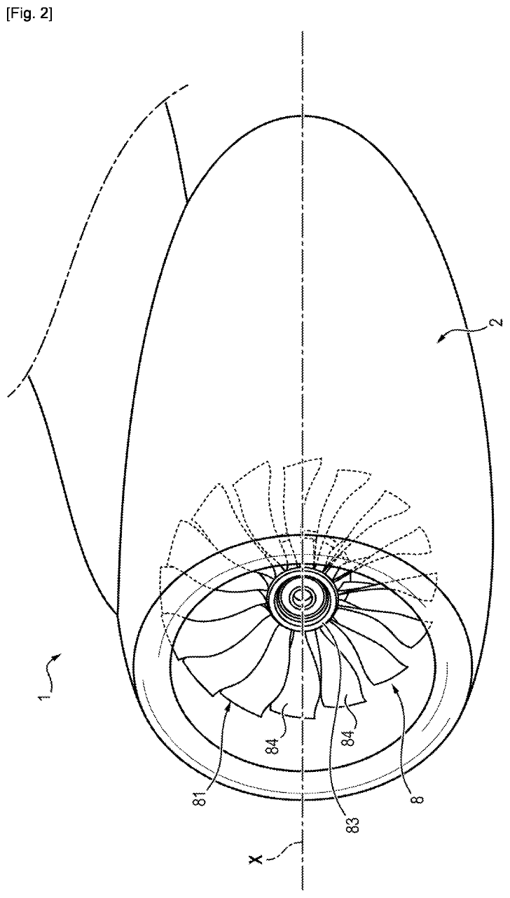

The aeronautical thruster 1 shown in FIG. 2 is a ducted-fan gas turbine engine. The gas turbine engine 1 shown comprises a nacelle 2 intended to be fixed to an aircraft fuselage, a fan 8 and a fairing surrounding the fan 8, the fairing being fixedly mounted on the nacelle 2. In the example illustrated in FIG. 2, the fairing of the fan 8 is disposed inside the nacelle 2.

The fan 8 comprises a fan rotor 81 able to be rotated with respect to the nacelle 2 about an axis of rotation X (which coincides with the main axis of the engine 1). The fan rotor 81 comprises a hub 83 and a plurality of blades 84 fixed to the hub 83 and extending in substantially radial directions from the hub 83. In the example illustrated in FIG. 2, the blades 84 are all identical, and arranged with a constant angular distance between two successive blades.

The fan 8 can be a variable pitch fan (VPF), i.e. the fan includes a mechanism for pivoting each blade 84 about a pitch axis so as to modify the pitch of the blades according to the phases of flight.

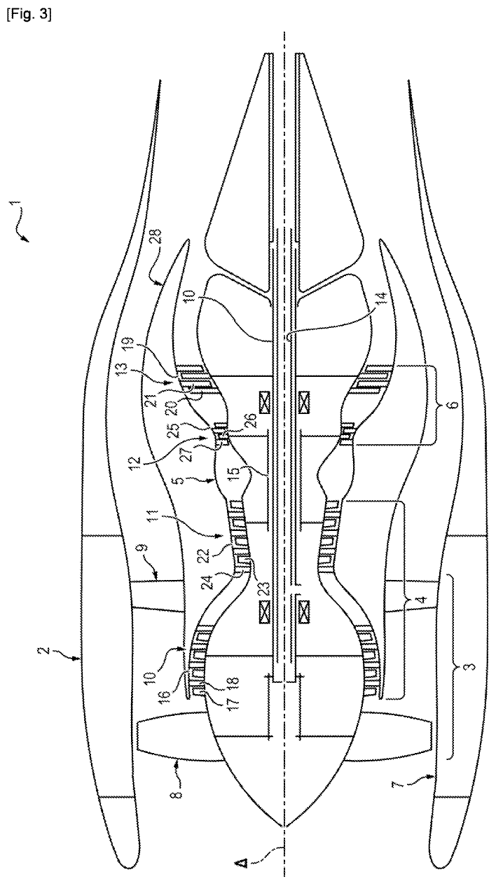

The aeronautical thruster 1 shown in FIG. 3, is a dual-body, turbofan gas turbine engine. The gas turbine engine may be an ultra-high bypass ratio (UHBR) gas turbine engine, i.e. having a bypass ratio of between approximately 15 and approximately 40.

The gas turbine engine 1 has a main axis X (or longitudinal axis).

The gas turbine engine 1 comprises a nacelle 2, a fan module 3, a compressor module 4, a combustion chamber 5 and a turbine module 6.

in the example illustrated in FIG. 3, the fan module 3 comprises a fan casing 7 mounted in a fixed position with respect to the nacelle, and a fan 8 suitable for being rotated with respect to the fan casing 7. The fan casing 7 includes fixed outlet vanes 9 (or “OGVs”) the function of which is to straighten the secondary airflow which flows out of the fan 8.

In the example illustrated in FIG. 3, the compressor module 4 comprises a low-pressure compressor 10 and a high-pressure compressor 11.

In addition, the turbine module 6 comprises a high-pressure turbine 12 and a low-pressure turbine 13.

The gas turbine engine 1 comprises a low-pressure shaft 14 connecting the low-pressure turbine 13 to the low-pressure compressor 10 and the fan 8, and a high-pressure shaft 15 connecting the high-pressure turbine 12 to the high-pressure compressor 11. The high-pressure shaft 15 is coaxial with the low-pressure shaft 14 and extends around the low-pressure shaft 14. The high-pressure shaft 15 and the low-pressure shaft 14 are rotatably mounted with respect to the nacelle 2, about the main axis X of the engine.

In one embodiment, the gas turbine engine 1 may comprise a fan shaft for rotating the fan 8 and a reduction gear having an input connected to the low-pressure shaft 14 and an output connected to the fan shaft. In this embodiment, the fan 8 is rotated at a speed lower than the speed of rotation of the low-pressure turbine 13. The reduction gear can thus independently optimise the speed of rotation of the fan 8 and the speed of rotation of the low-pressure turbine 13 and the low-pressure compressor 10.

The fan module 3, the low-pressure compressor 10, the low-pressure turbine 13 and the low-pressure shaft 14 (and, if applicable, the reduction gear and the fan shaft) together form the low-pressure body of the engine 1. The low-pressure turbine 13 is proper to rotate the low-pressure compressor 10 and the fan 8 via the low-pressure shaft 14 (and also, where applicable, via the reduction gear and the fan shaft).

More specifically, the low-pressure compressor 10 comprises a low-pressure compressor casing 16, fixedly mounted with respect to the nacelle 2, a low-pressure compressor rotor 17, and a low-pressure compressor stator 18. The low-pressure compressor rotor 17 can be rotated with respect to the low-pressure compressor stator 18, about the main axis X of the engine 1. The low-pressure compressor rotor 17 comprises moving blades. The low-pressure compressor stator 18 comprises fixed vanes (also called “guide vanes” or “flow-straightener vanes”) which are fixedly mounted on the low-pressure compressor casing 16, being interposed between the moving blades. The function of these fixed vanes is to guide the primary airflow through the low-pressure compressor 10.

Similarly, the low-pressure turbine 13 comprises a low-pressure turbine casing 19, fixedly mounted with respect to the nacelle 2, a low-pressure turbine rotor 20, and a low-pressure turbine stator 21. The low-pressure turbine rotor 20 can be rotated with respect to the low-pressure turbine stator 21 about the main axis X of the engine 1. The low-pressure turbine rotor 20 comprises moving blades. The low-pressure turbine stator 21 comprises fixed vanes which are fixedly mounted on the low-pressure turbine casing 19, being interposed between the moving blades. The function of these fixed vanes is to guide the primary airflow through the low-pressure turbine 13.

The low-pressure turbine rotor 20 is connected to the low-pressure compressor rotor 17 via the low-pressure shaft 14. When the engine 1 is running, rotation of the low-pressure turbine rotor 20 causes rotation of the low-pressure compressor rotor 17.

The high-pressure compressor 11, the high-pressure turbine 12 and the high-pressure shaft 15 together form the high-pressure body of the engine 1. The high-pressure turbine 12 is able to rotate the high-pressure compressor 11 via the high-pressure shaft 15.

More specifically, the high-pressure compressor 11 comprises a high-pressure compressor casing 22, fixedly mounted with respect to the nacelle 2, a high-pressure compressor rotor 23, and a high-pressure compressor stator 24. The high-pressure compressor rotor 23 can be rotated with respect to the high-pressure compressor stator 24, about the main axis X of the engine 1. The high-pressure compressor rotor 23 comprises moving blades. The high-pressure compressor stator 24 comprises fixed vanes (also called “guide vanes” or “flow-straightener vanes”) which are fixedly mounted on the high-pressure compressor casing 22, being interposed between the moving blades. The function of these fixed vanes is to guide the primary airflow through the high-pressure compressor 11.

In one embodiment, the vanes of the high-pressure compressor stator 24 can be variable-pitch vanes, in order to ensure the operability of the high-pressure compressor 11 and increase its surge margin.

Similarly, the high-pressure turbine 12 comprises a high-pressure turbine casing 25, fixedly mounted with respect to the nacelle 2, a high-pressure turbine rotor 26, and a high-pressure turbine stator 27. The high-pressure turbine rotor 26 can be rotated with respect to the high-pressure turbine stator 27, about the main axis X of the engine 1. The high-pressure turbine rotor 26 comprises moving blades. The high-pressure turbine stator 27 comprises fixed vanes which are fixedly mounted on the high-pressure turbine casing 25, being interposed between the moving blades. The function of these fixed vanes is to guide the primary airflow through the high-pressure turbine 12.

The high-pressure turbine rotor 26 is connected to the high-pressure compressor rotor 23 via the high-pressure shaft 15. When the engine 1 is running, rotation of the high-pressure turbine rotor 26 causes rotation of the high-pressure compressor rotor 23.

Examples of guide vanes are the outlet vanes 9 of the fan module 3, the fixed vanes of the stator 18 of the low-pressure compressor 10, the fixed vanes of the stator 24 of the high-pressure compressor 11, the fixed vanes of the stator 27 of the high-pressure turbine 12 and the fixed vanes of the stator 21 of the low-pressure turbine 13.

When the engine 1 is running, the fan 8 and the low-pressure compressor 10 are rotated by the low-pressure turbine 13. Similarly, the high-pressure compressor 11 is rotated by the high-pressure turbine 12.

Air is drawn in by fan 8. The air drawn in by the fan 8 is divided into a primary and a secondary airflow, which flow from upstream to downstream of the gas turbine engine 1.

The primary airflow flows from upstream to downstream of the gas turbine engine 1 in a primary duct, passing successively through the low-pressure compressor 10, the high-pressure compressor 11, the combustion chamber 5 where it is mixed with fuel to serve as an oxidant, the high-pressure turbine 12 and the low-pressure turbine 13. The passage of the primary airflow through the high-pressure turbine 12 and the low-pressure turbine 13 causes the rotors 26 and 20 of the turbines to rotate, which in turn rotate the rotors 23 and 17 of the high-pressure and low-pressure compressors, as well as the fan 8, via the high-pressure shaft 15 and the low-pressure shaft 14. The primary airflow escapes from the engine 1 through an exhaust casing 28, located downstream of the low-pressure turbine casing 19.

The secondary airflow (also known as the “bypass flow”) flows from upstream to downstream of the gas turbine engine 1 in a secondary duct. This secondary airflow does not pass into the combustion chamber 5 and does not drive the turbines 12 and 13. The secondary airflow serves both to cool the periphery of the engine body and can generate the majority of the thrust provided by the gas turbine engine. The secondary airflow flows through the fixed vanes 9 mounted on the fan casing 7, downstream of the fan 8.

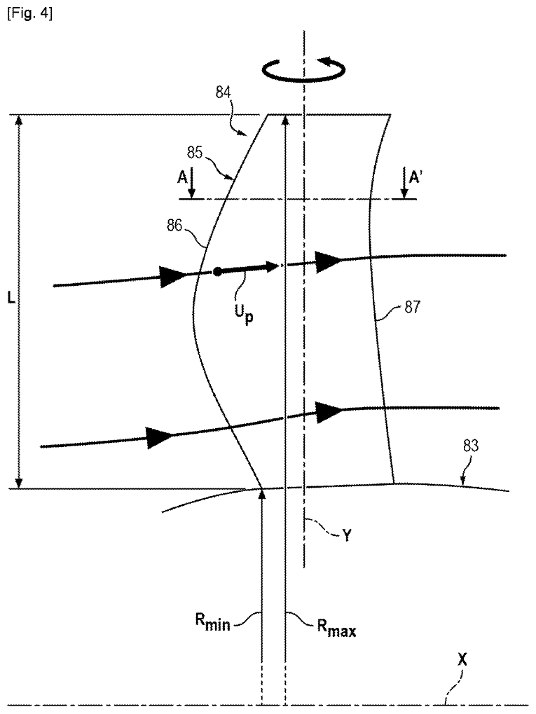

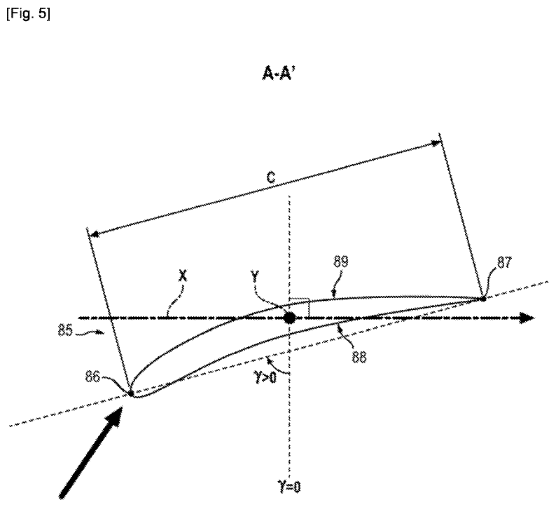

FIGS. 4 and 5 schematically show a fan or propeller blade 84.

However, the invention can also be applied to other aeronautical thruster blades, such as turbine or compressor blades, for example. The blade may be a blade of a rotating part of the aeronautical thruster or a vane of a fixed part of the aeronautical thruster.

In FIGS. 4 and 5, the fan blade 84 comprises a profiled part 85 with an aerodynamic profile extending radially from the hub 83.

The profiled part 85 has a leading edge 86, a trailing edge 87, an intrados surface 88 and an extrados surface 89.

In addition, in the example shown in FIGS. 4 and 5, the fan blade 84 is rotatably mounted with respect to the hub 83 about a pitch axis Y, which enables the angle of incidence of the profiled part 85 with respect to the main axis X of the engine to be changed, and therefore with respect to a direction of the incoming airflow.

As illustrated in FIG. 4, a minimum radius Rₘᵢₙ of the profiled part 85 is defined as a distance between a point on the leading edge 86 of the profiled part 85 closest to the main axis X of the aeronautical thruster, and the main axis X of the aeronautical thruster.

In the case where the blade has a variable pitch, the minimum radius Rₘᵢₙ of the profiled part 85 being defined as a distance between a point of the leading edge 86 of the profiled part 85 closest to the main axis X of the aeronautical thruster, and the main axis X of the aeronautical thruster, when the blade 84 is positioned with a pitch angle at which the blade 84 is feathered

A variable blade setting is said to be “feathered” when the pitch angle of the blade is such that the aerodynamic drag generated by the blade in the airflow through the fan is minimal. The feathered position is the position assumed by a fan blade when it is left free to orientate itself naturally in the airflow passing through the fan from upstream to downstream parallel to the main axis of the aeronautical thruster, the rotating part not being driven in rotation.

A maximum radius Rₘₐₓ is defined as a distance between a point of the profiled part 85 furthest away from the main axis X of the aeronautical thruster, and the main axis of the aeronautical thruster.

A span L of the profiled part 85 is defined as a difference between the maximum radius Rₘₐₓ of the profiled part 85 and the minimum radius Rₘᵢₙ of the profiled part 85.

In FIG. 4, the plane of section A-A′ is a plane parallel to the main axis of the engine X and which intersects the profiled part 85 at a point on the leading edge 86 and a point on the trailing edge 87, the plane of section A-A′ being orthogonal to the pitch axis Y.

As illustrated in FIG. 5 representing a section through the profiled part 85 along the section plane A-A′, a local chord is defined as a segment connecting a point on the leading edge 86 and a point on the trailing edge 87, the point on the leading edge and the point on the trailing edge being located at the same radial distance from the main axis X of the engine. Thus, the local chord length C is defined as a distance between a point on the leading edge 86 and a point on the trailing edge 87 located at the same radial distance from the main axis X of the engine.

In FIG. 5, the angle γ is the pitch angle of the blade. The pitch angle γ is defined as the angle between the local chord C measured a radial distance equal to 0.75×Rₘₐₓ from the main axis X of the engine, and the main axis of the engine.

In the case of a blade with variable pitch, when the blade is feathered, the pitch angle γ is generally equal to approximately 90° (plus or minus 15°).

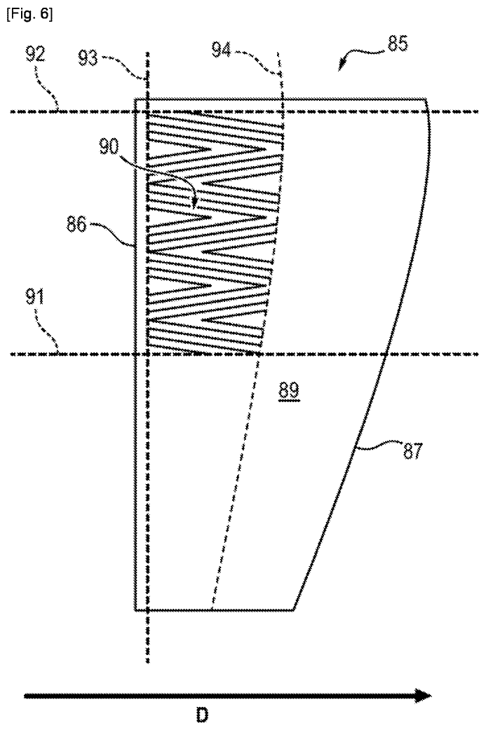

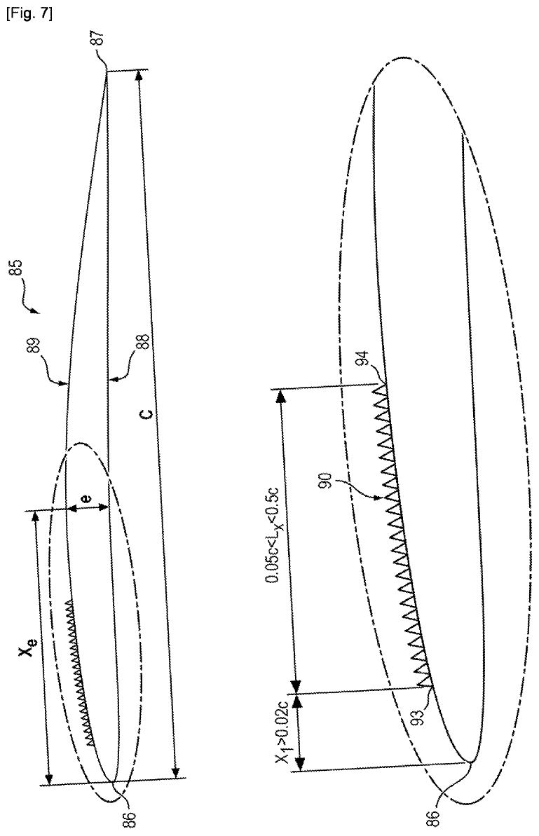

As can be seen in FIGS. 6 and 7, the extrados surface 89 of the profiled part 85 has a textured surface portion 90 with an alternation of projections and recesses. The rest of the extrados surface 89, extending outside the textured surface portion 90, is smooth, i.e. it has no projections or recesses. The arrow D represents the main flow direction.

The textured surface portion 90 is bounded by a first boundary line 91, a second boundary line 92, a third boundary line 93 and a fourth boundary line 94.

The textured surface portion 90 extends radially between the first boundary line 91 and the second boundary line 92.

The first boundary line 91 is located at a radial distance from the main axis X of the aeronautical thruster greater than or equal to the sum of the minimum radius Rₘᵢₙ and 20% of the span L of the profiled part 85. In other words, the first boundary line 91 is located at a distance from the main axis X greater than or equal to Rₘᵢₙ+0.2×L.

Preferably, the first boundary line 91 is located at a radial distance from the main axis X of the aeronautical thruster greater than or equal to the sum of the minimum radius Rₘᵢₙ and 50% of the span L of the profiled part 85. In other words, the first boundary line 91 is located at a distance from the main axis X greater than or equal to Rₘᵢₙ+0.5×L.

The second boundary line 92 is located at a radial distance from the main axis X of the aeronautical thruster less than or equal to the sum of the minimum radius Rₘᵢₙ and 95% of the span L of the profiled part 85. In other words, the second boundary line 92 is located at a distance from the main axis X less than or equal to Rₘᵢₙ+0.95×L.

The second boundary line 92 is located at a radial distance from the main axis X of the aeronautical thruster less than or equal to the sum of the minimum radius Rₘᵢₙ and 90% of the span L of the profiled part 85. In other words, the second boundary line 92 is located at a distance from the main axis X less than or equal to Rₘᵢₙ+0.90×L.

The textured surface portion 90 extends axially between the third boundary line 93 and the fourth boundary line 94.

The third boundary line 93 is defined as all the points on the upper surface 89 located at an axial distance from the leading edge 86 greater than or equal to 2% of the local chord length C. In other words, the third boundary line is located at an axial distance from the leading edge 86 greater than or equal to 0.02×C.

Preferably, the third boundary line 93 is defined as all the points of the extrados surface 89 located at an axial distance from the leading edge 86, greater than or equal to 5% of the local chord length C, more preferably greater than or equal to 10% of the local chord C. In other words, the third boundary line 93 is located at an axial distance, measured in the direction of the local chord at the same radial distance from the main axis X of the engine, greater than or equal to 0.05×C, preferably greater than or equal to 0.1×C.

The fourth boundary line 94 is defined as all the points on the upper surface 89 located at an axial distance from the leading edge 86, less than or equal to 50% of the local chord length C. In other words, the fourth boundary line 94 is located at an axial distance, measured in the direction of the local chord at the same radial distance from the main axis X of the engine, less than or equal to 0.5×C.

Preferably, the fourth boundary line 94 is located at an axial distance from the leading edge 86, less than or equal to 40% of the local chord length C, more preferably less than or equal to 30% of the local chord C. In other words, the fourth boundary line 94 is located at an axial distance, measured in the direction of the local chord at the same radial distance from the main axis X of the engine, of less than or equal to 0.4×C, preferably less than or equal to 0.3×C.

The textured surface portion 90 thus defined lies in an area in which a recirculation bubble and/or partially detached flow is likely to occur.

The presence of projections and/or recesses in this area makes it possible to recreate a turbulent flow at this point, in place of a recirculation bubble at partial speed (i.e. during the take-off and landing phases of the aircraft) and to reduce parietal friction and aerodynamic losses at nominal speed (i.e. at cruise speed). This enables the noise generated by the fan to be reduced during take-off and landing, without impacting on the performance of the aeronautical thruster at cruise speed.

In the example illustrated in FIGS. 6 and 7, the alternation of projection and recess extends over the entire textured surface portion 90, i.e. from the first boundary line 91 to the second boundary line 92, and from the third boundary line 93 to the fourth boundary line 94.

FIG. 7 schematically shows a profile of the profiled part 85 of the blade 84, i.e. a section of the profiled part 85 in a cross-sectional plane. The cross-sectional plane is defined as a plane parallel to the main axis X and containing a point on the leading edge and a point on the trailing edge located at equal distances from the main axis X.

If the blade 84 is a variable pitch blade, the cross-sectional plane can be defined as a plane orthogonal to the pitch axis Y.

As illustrated in FIG. 7, in each cross-sectional plane, the profiled part 85 has a maximum thickness eₘₐₓ at a given point on the upper surface 89, located at an axial distance Xₑₘₐₓ from the leading edge 86 measured parallel to the local chord. The fourth boundary line 94 is located upstream of the point where the thickness of the profiled part is maximum. In other words, each of the points on the fourth boundary line 94 is located at an axial distance from the leading edge 86 that is strictly less than Xₑₘₐₓ.

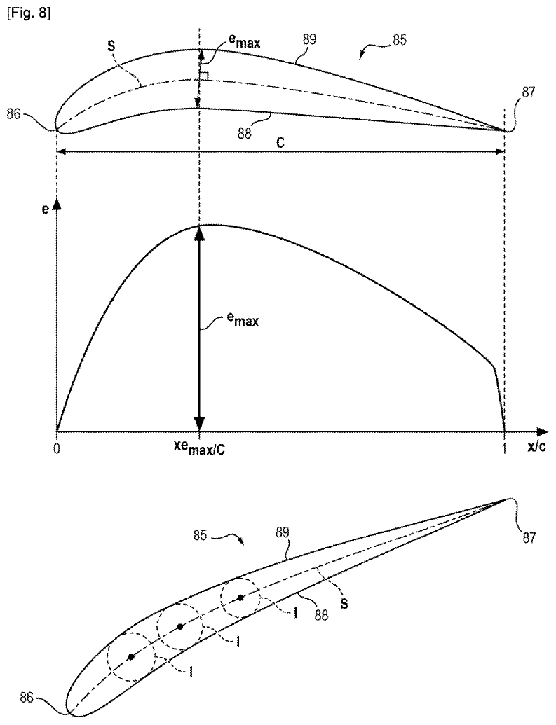

As illustrated in FIG. 8, in a given cross-sectional plane, the thickness e is defined as the distance between the intrados surface 88 and the extrados surface 89 of the profiled part 85 measured perpendicular to a camber line S.

The camber line S is defined as the set of points located midway between the intrados surface line and the extrados line in the transverse plane (the intrados line being defined as the line of intersection between the intrados surface 88 and the radial plane and the extrados line being defined as the line of intersection between the extrados surface 89 and the radial plane). The camber line S can, for example, be obtained by positioning inscribed circles I inside the profile of the profiled part. The camber line is defined by the set of points that constitute the centres of the inscribed circles.

For any considered point of the textured surface portion 90, the thickness e of the profiled part 85 at the considered point is less than 12% of the local chord, preferably less than or equal to 10% of the local chord, or more preferably less than or equal to 7% of the local chord.

The thickness of the profiled part 85 is low, particularly at the top, in order to reduce centrifugal forces and therefore improve the mechanical strength of the blade 84.

FIG. 9 schematically shows an alternation of projections 95 and recesses 96 formed on the textured surface portion 90.

In this example, the projections 95 are in the form of ribs, in relief from the rest of the extrados surface 89.

The textured surface portion 90 comprises first zones 90A and second zones 90B, the second zones 90B being arranged alternately with the first zones 90A along a radial direction with respect to the main axis X of the aeronautical thruster.

Each first zone 90A has a series of first ribs, oriented at a first angle with respect to the main axis X of the aeronautical thruster, and each second zone 90B has a series of second ribs oriented at a second angle with respect to the main axis X of the aeronautical thruster, the second angle being different from the first angle.

The angle α (α₁, α₂, . . . ) of a rib can be defined as the angle between the main axis X of the aeronautical thruster and the projections or ribs (when these are projected in a plane passing through the main axis X and passing—partially—through the blade). If the blade has a variable pitch, this definition is valid when the blade has the pitch corresponding to the aerodynamic design point (ADP) or the operating point at cruise speed. For an unducted propeller, this corresponds to a pitch angle γ, as defined in FIG. 5, which varies between 60° and 70° on the cross-section at 0.75×Rₘₐₓ.

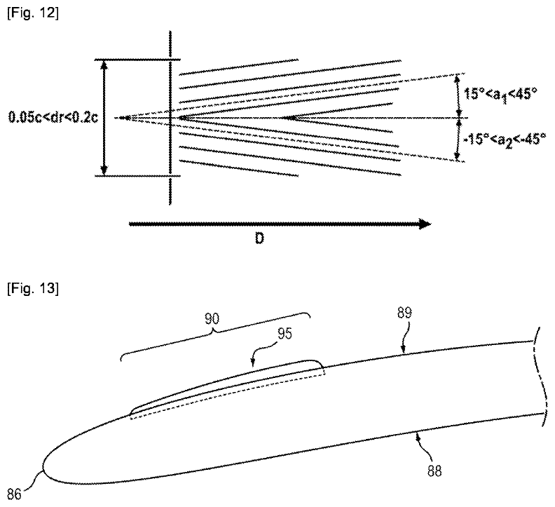

As illustrated in FIG. 12, the first angle α₁ may be between +15° and 45°. The second angle may be symmetric with respect to the first angle, i.e. the second angle α₂ is between −45° and −15°. In a favoured embodiment, α₂=−α₁. The arrow D represents the main flow direction.

In this way, the first and second ribs together form a herringbone pattern.

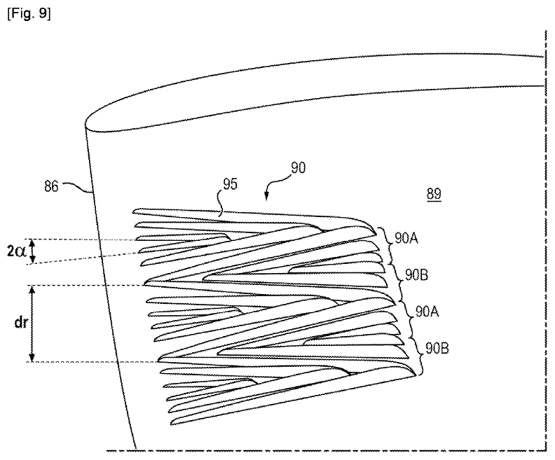

FIG. 10A schematically shows a first example of a rib 95.

The rib 95 has a base 97 facing the extrados surface and an apex 98 located at a distance from the base 97.

A cross-section of the rib is defined as a section taken in a sectional plane orthogonal to a longitudinal direction of rib 95.

In this first example, the rib 95 has a rectangular cross-section. In other words, the rib 95 has a constant thickness t in cross-section from its base 97 to its apex 98.

In a variant illustrated on the right of FIG. 10A, the rib 95 may have a rounded apex 98.

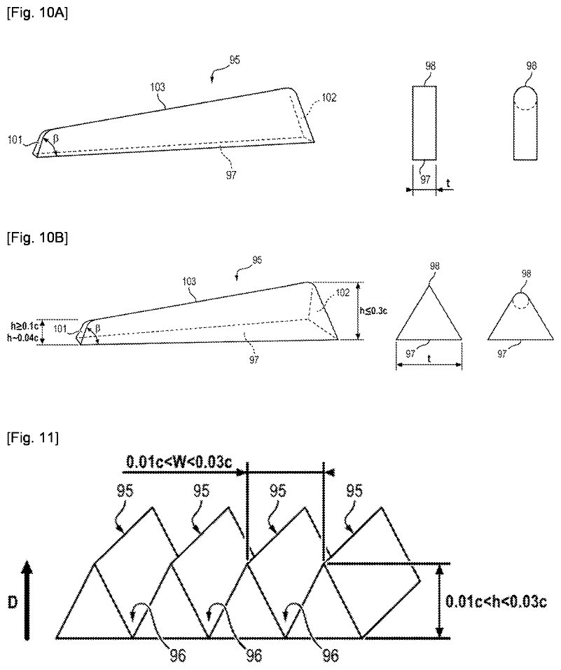

The FIG. 11 schematically shows a second example of a rib 95. The arrow D represents the main flow direction.

The rib 95 has a base 97 facing the extrados surface and an apex 98 located at a distance from the base 97.

In this second example, the rib 95 is triangular in cross-section. In other words, the rib 95 has a cross-sectional thickness t which decreases continuously (or in a strictly monotonic manner) from its base 97 to its apex 98.

In a variant illustrated on the right of FIG. 10B, the rib 95 may have a rounded apex 98.

In these two examples, the apex 98 of the rib 95 has a height h, measured with respect to the base 97, greater than the width t of the base 97.

In addition, each rib 95 has an upstream end face 101 and a downstream end face 102.

Each rib 95 has a ridge 103 extending from the upstream end face 101 to the downstream end face 102.

The ridge 103 has an upstream end and a downstream end.

The upstream end face has a flat portion extending from the base 97 and a rounded junction portion extending from the flat portion to the upstream end of the ridge 103. The flat portion forms a first non-zero angle β with the base 97. The first angle β is less than or equal to 90°.

The first angle β is preferably between 20° and 70°.

The downstream end face 102 has a rounded junction portion extending from the downstream end of the ridge 103 and a flat portion extending from the rounded junction portion to the base 97. The flat portion forms a second non-zero angle γ with the base 97. The second angle γ is less than or equal to 90°.

The second angle ψ is preferably between 20° and 70°.

The ridge 103 has a height h measured with respect to the base 97 which increases in a strictly monotonic manner from the upstream end face 101 to the downstream end face 102.

For example, the ridge has a first height measured at its upstream end greater than or equal to 0.04% of the local chord (i.e. h>0.0004×C), preferably greater than or equal to 1% of the local chord (i.e. h≥0.01×C), and a second height measured at its downstream end less than or equal to 3% of the local chord (i.e. h≤0.03×C). This makes it possible to include ribs having a characteristic height corresponding to that of the boundary layers and/or recirculation bubbles that may appear at partial speed on the extrados of the fan blades close to the leading edge.

As illustrated in FIG. 11, the projections and/or recesses form a repetitive pattern having a constant pitch w between two consecutive projections 95 or between two consecutive recesses 96, the pitch being between ⅓ and 3 times a height of a projection, or between ⅓ and 3 times a depth of a recess. In other words, ⅓≤w/h≤3.

The pitch w is preferably between 1% and 3% of the local chord, i.e. 0.01<w/C<0.03.

As illustrated in FIG. 12, the radial width of a rib pattern is between 5% and 20% of the chord. This pattern of ribs can be repeated identically or homothetically in one or more directions (radial, axial, etc.) over the textured surface portion 90.

As illustrated in FIG. 13, the base 97 of the ribs 95 may be located below the level of the smooth portion of the extrados surface 89 which extends away from the textured surface portion 90, while the apex of the ribs 95 may be located above the level of this smooth portion.

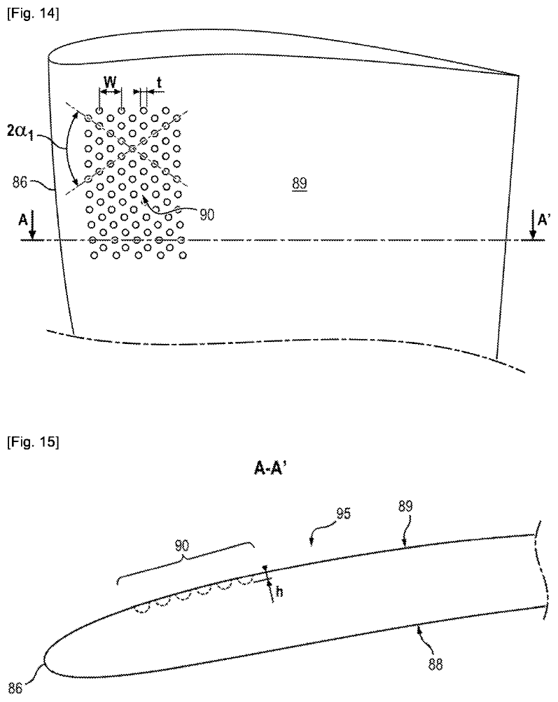

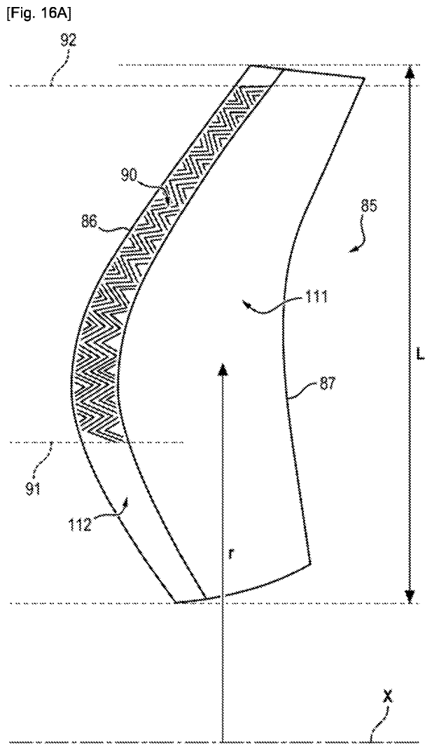

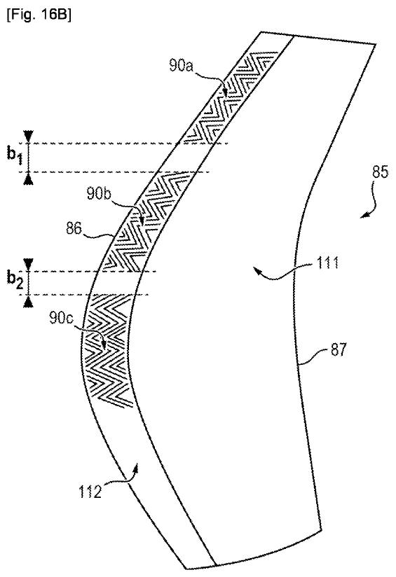

In the embodiment illustrated in FIGS. 14 and 15, the textured surface portion 90 has recesses 96. The rest of the extrados surface 89, extending outside the textured surface portion 90, is smooth, i.e. it has no projections or recesses.

In this embodiment, the recesses 96 have the shape of a portion of a sphere, for example a hemispherical shape.

Each recess 96 has a depth h and a diameter t, the depth h preferably being equal to 0.5×t.

The recesses 96 form a repeating pattern with a constant pitch w between two consecutive or adjacent recesses 96, the pitch being between ⅓ and 3 times the depth h of a recess.

In addition, the pitch w is preferably between 1% and 3% of the local chord.

The recesses 96 are arranged to form first rows parallel to each other and oriented at a first angle with respect to the main axis X of the aeronautical thruster, and second rows parallel to each other and oriented at a second angle with respect to the main axis X of the aeronautical thruster, different from the first angle.

As illustrated in FIG. 14, the first angle α₁ may be between +15 and +45°. The second angle may be symmetric with respect to the first angle, in other words the second angle α₂=−α₁ is between −45° and −15°.

Hence, the second rows form an angle equal to 2α₁ with the first rows.

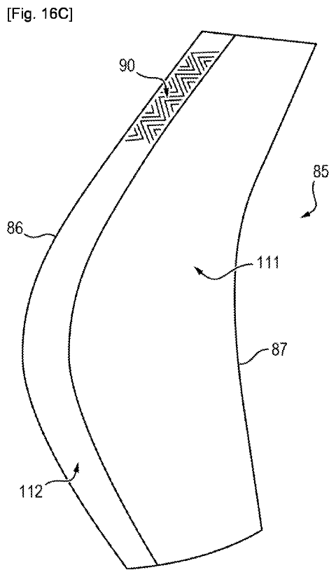

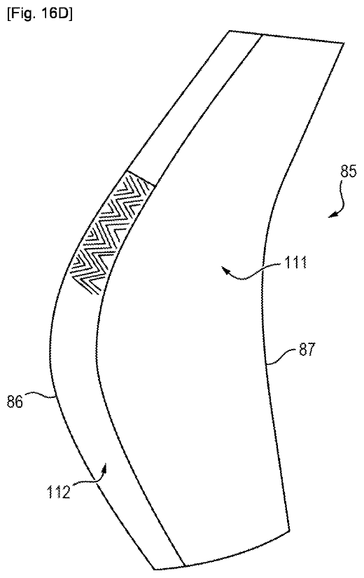

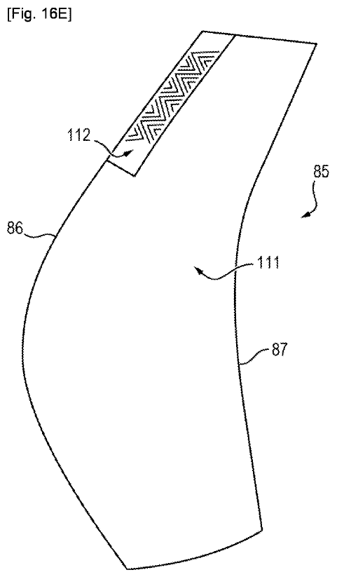

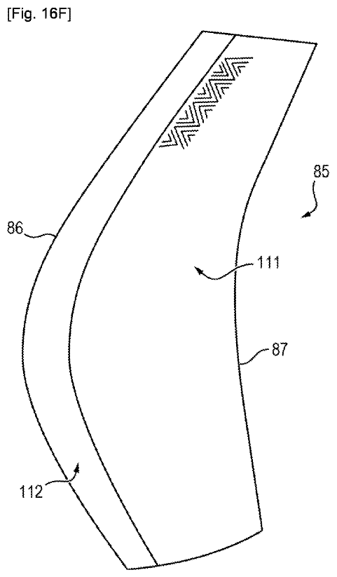

FIGS. 16A to 16F illustrate different configurations of the textured surface portion 90.

In a first configuration illustrated in FIG. 16A, the profiled part 85 comprises a core 111 made of composite material and an insert 112 fixed to the core 111. The insert 112 forms the leading edge 86 of the profiled part 85.

The insert 112 may be a metal component, such as a metal reinforcement fixed to the core 111, or a heating mat fixed to the core 111 (in particular, in the case of a propeller blade, the heating mat provides a de-icing function for the leading edge area most exposed to ice).

The projections 95 and/or recesses 96 are formed solely on the insert 112, all along the leading edge 86 from the first boundary line 91 to the second boundary line 92 delimiting the textured surface portion 90. This makes it easy to machine the patterns of projections and/or recesses on the surface of the blade, as well as limiting the wear on the patterns that can occur in service.

In a second configuration illustrated in FIG. 16B, the extrados surface 89 comprises a plurality of textured surface portions 90a, 90b, 90c having projections and/or recesses. The textured surface portions 90a, 90b, 90c are arranged alongside one another, along the leading edge 86. The projections 95 and/or recesses 96 are formed only on the insert 112. Each textured surface portion 90a, 90b, 90c is separated from a nearest textured surface portion by a distance (in the radial direction) b₁, b₂ of between 1% and 35% of the span L of the profiled part 85, preferably between 2% and 15% of the span of the profiled part 85.

In a third configuration illustrated in FIG. 16C, the projections 95 and/or recesses 96 are formed solely on the insert 112, in a portion of the insert 112 located in the vicinity of an end furthest radially from the main axis X of the aeronautical thruster.

In a fourth configuration shown in FIG. 16D, the leading edge 86 is formed partly by the metal reinforcement 112 and partly by the composite material core 111.

More precisely, a portion of the leading edge 86 further away from the main axis of the aeronautical thruster is formed by the composite material core 111, and a portion of the leading edge 86 closer to the main axis of the aeronautical thruster is formed by the metal reinforcement 112.

The projections 95 and/or recesses 96 are formed solely on the metal insert 112, in a portion of the insert 112 located in the vicinity of an end furthest radially from the main axis X of the aeronautical thruster.

In a fifth configuration shown in FIG. 16E, the leading edge 86 is formed partly by the metal reinforcement 112 and partly by the composite material core 111.

More precisely, a portion of the leading edge 86 closer to the main axis of the aeronautical thruster is formed by the composite material core 111, and a portion of the leading edge 86 further away from the main axis of the aeronautical thruster is formed by the metal reinforcement 112.

The projections 95 and/or recesses 96 are formed solely on the insert 112, in a part of the insert 112 located in the vicinity of an end furthest radially from the main axis X of the aeronautical thruster.

When the projections 95 and/or recesses 96 are formed on the insert 112, these projections and recesses can be formed by machining directly in the metal reinforcement 112.

In a sixth configuration illustrated in FIG. 16F, the projections 95 and/or recesses 96 are formed solely on the composite material core 111. This makes it possible to limit the weight of the blade, in particular when a metal reinforcement is not required for reasons of mechanical resistance to bird ingestion.

In FIGS. 15C, 15D, 15E and 15F, the projections 95 and/or recesses 96 are located in a radial position either above the radial position of the local chord maximum C, or above the position of the leading edge belly 86, in a zone where detachments at partial speed may occur.

When the projections 95 and/or recesses 96 are formed on the composite material core 111, these projections and/or recesses may be formed directly in the composite material or in a film which is applied to the extrados surface 89, for example by gluing.

1. An aeronautical thruster comprising a fixed part and a rotating part proper to be driven in rotation with respect to the fixed part about a main axis of the aeronautical thruster,
one of the fixed part and the rotating part comprising a central component and a blade, the blade comprising a profiled part having an aerodynamic profile extending radially from the central component,
the profiled part having a leading edge, a trailing edge, an intrados surface and an extrados surface,
wherein the intrados surface or the extrados surface comprises a textured surface portion having a series of projections, of recesses or of both projections and recesses,
any considered point of the textured surface portion being located at a radial distance from the main axis equal to the sum of a minimum radius of the profiled part and between 20% and 95% of a span of the profiled part, and is located at a distance from the leading edge of between 2% and 50% of a local chord length,
wherein the span of the profiled part is defined as a difference between a maximum radius of the profiled part and a minimum radius of the profiled part,
the maximum radius of the profiled part being defined as a distance between a point of the profiled part furthest away from the main axis, and the main axis, and the minimum radius of the profiled part being defined as a distance between a point of the leading edge of the profiled part closest to the main axis, and the main axis, or
in the case where the blade is a variable pitch blade, the minimum radius being defined as a distance between a point of the leading edge of the profiled part closest to the main axis, and the main axis, when the blade is positioned with a pitch angle at which the blade is feathered,
and wherein the local chord length is a distance between a point of the leading edge and a point of the trailing edge, the point of the leading edge and the point of the trailing edge being located at the same radial distance from the main axis as the considered point,
and wherein for any considered point of the textured surface portion, a thickness of the profiled part at the considered point is less than 12% of the local chord.

2-4. (canceled)

5. The aeronautical thruster according to claim 1, wherein for a given radial distance, the profiled part has a maximum thickness at a given point of the intrados surface or of the extrados surface, the given point being located at a distance from the leading edge of between 10% and 45% of the local chord.

6. The aeronautical thruster according to claim 1, wherein the profiled part comprises a core made of composite material and an insert fixed to the core and forming the leading edge of the profiled part, and wherein the projections, the recesses or both the projections and the recesses, are formed solely on the insert.

7. The aeronautical thruster according to claim 6, wherein the insert is a metal reinforcement fixed to the core or a heating mat fixed to the core.

8. The aeronautical thruster according to claim 6, wherein the projections, the recesses or both the projections and the recesses, are located at a radial distance from the main axis greater than a radial distance from the maximum of the local chord of the blade with respect to the main axis, or greater than the radial distance from a belly of the leading edge with respect to the main axis.

9. (canceled)

10. The aeronautical thruster according to claim 1, wherein:
the projections have a height of between 0.04% of the local chord and 3% of the local chord,
the recesses have a depth of between 0.04% of the local chord and 3% of the local chord,
or both the projections and the recesses have a height of between 0.04% of the local chord and 3% of the local chord.

11. The aeronautical thruster according to claim 1, wherein the projections, the recesses or both the projections and the recesses, form a repetitive pattern having a constant pitch between two consecutive projections or between two consecutive recesses, the pitch being between ⅓ and 3 times a height of a projection or between ⅓ and 3 times a depth of a recess.

12. The aeronautical thruster according to claim 1, wherein the projections comprise ribs.

13. The aeronautical thruster according to claim 12, wherein each rib has a base and a ridge having a height measured with respect to the base which increases strictly monotonically from upstream to downstream in a direction of flow of gases through the aeronautical thruster.

14. The aeronautical thruster according to claim 13, wherein the ridge has an upstream end and a downstream end, and each rib comprises an upstream end face extending from the base to the upstream end of the ridge, forming a first non-zero angle with the base, less than or equal to 90°, and a downstream end face extending from a downstream end of the ridge to the base, forming a second non-zero angle with the base less than or equal to 90°.

15. The aeronautical thruster according to claim 14, wherein the upstream end face has a flat portion extending from the base and a rounded junction portion extending from the flat portion to the upstream end of the ridge.

16. The aeronautical thruster according to claim 14, wherein the downstream end face has a rounded junction portion extending from the downstream end of the ridge and a flat portion extending from the rounded junction portion to the base.

17. The aeronautical thruster according to claim 12, wherein each rib has a section with triangular cross-section, having a base and an apex, the apex having a height, measured with respect to the base, greater than the width of the base.

18. The aeronautical thruster according to claim 12, wherein the textured surface portion comprises first zones and second zones disposed in alternation with the first zones in a radial direction with respect to the main axis, and wherein each first zone has a series of first ribs, oriented at a first angle with respect to the main axis and each second zone has a series of second ribs oriented at a second angle with respect to the main axis, the second angle being different from the first angle.

19. The aeronautical thruster according to claim 18, wherein the first angle and the second angle are adjacent and the first angle is between +15° and +45° with respect to the main axis and the second angle is between −15° and −45° with respect to the main axis.

20. The aeronautical thruster according to claim 18, wherein the alternation of first zones and second zones has a spatial period of between 5% and 20% of the local chord.

21. The aeronautical thruster according claim 18, wherein each first rib converges towards a second respective rib in the upstream-downstream direction.

22. The aeronautical thruster according to claim 1, wherein the recesses comprise cavities each being partially spherical.

23. The aeronautical thruster according to claim 1, comprising:
a fan, and wherein the blade is a blade of the fan of the aeronautical thruster, or
a propeller, and wherein the blade is a blade of the propeller of the aeronautical thruster.

24. The aeronautical thruster according to claim 23, comprising a driving turbine of the fan or propeller, a fan shaft connected to the fan or a propeller shaft connected to the propeller, a turbine shaft connected to the turbine and a reduction gear having an input connected to the turbine shaft and an output connected to the fan shaft or to the propeller shaft, such that in operation, the fan or the propeller is rotated by the turbine at a speed of rotation less than a speed of rotation of the turbine.
